(19) United States
(12) Patent Application Publication
(10) Pub. No.: US 2007/0089700 A1
(43) Pub. Date: Apr. 26, 2007

(54) Castable ceramic port liner

(75) Inventor: John W. Cogburn, Conyers, GA (US)

Correspondence Address: LEONARD TACHNER, A PROFESSIONAL LAW;CORPORATION, 17961 SKY PARK CIRCLE, SUITE 38-E, IRVINE, CA, 92614, US

(73) Assignee: Ceradyne, Inc.

(21) Appl. No.: 11/259,286

(22) Filed: Oct. 26, 2005

(51) Int. Cl. F02F 1/42; F01N 7/14; F02B 75/08

(52) U.S. Cl. 123/193.5; 60/272; 123/668

(57) ABSTRACT

Fused silica exhaust port liners for internal combustion engines are cast into engine head metals such as gray iron by employing compliant insulating layers to protect the liner against high casting temperatures and subsequently dampen engine vibrations that could otherwise structurally damage the liners.

### BACKGROUND OF THE INVENTION

1. Field of the Invention

This invention relates generally to ceramic liners for use in internal combustion engines and more particularly to a ceramic liner for use in port liners, or other high temperature engine components.

2. Background Art

Today's engine components have to be fabricated at significantly reduced costs while achieving superior results in order for engine manufacturers to remain competitive. However, port liners that have become less complicated have either failed to produce superior heat insulation capabilities or have become less durable, increasing maintenance costs.

The heat-insulated port liner for a device composed of a cast metal disclosed in U.S. Pat. No. 4,676,064 by Yoshinori Narita et al. includes a tubular port liner composed of a ceramic material, a first covering layer disposed on the outer surface of the liner and composed of refractory fibers, and a second covering layer disposed on the outer surface of the first covering layer and composed of a metal having a melting point not lower than the melting point of the cast metal. The port liner is made from a material having a low coefficient of thermal expansion and high thermal resistance, such as, aluminum titanate. Unfortunately, no range is given for the coefficient of thermal expansion needed for the port liner used with a cast aluminum cylinder head. It is well known that the melting point of aluminum is lower than that of cast iron and that aluminum titanate can be effectively used with molten aluminum. However, aluminum titanate may only be successfully cast in very simple geometries due to the additional stresses it will encounter upon exposure to molten cast iron. Further, the stability of aluminum titanate varies with the composition. The port liner disclosed by Narita could be destroyed during the casting process if used with a cast iron cylinder head, depending upon the complexity of the geometry and the composition of the aluminum titanate.

Additionally, since the first covering layer is unsupported, settling of the refractory fibers occurs when the fibers are exposed to typical engine vibration experienced during operation. This settling effect limits the effectiveness of the insulation and may lead to the destruction of the entire insulation layer. Once destroyed, the insulation would be free to disintegrate and enter the exhaust passage.

An improved apparatus for insulating the exhaust passage of an internal combustion engine is disclosed in U.S. Pat. No. 5,404,716 by Alan W. Wells et al. The insulating element is quilted and has ceramic fiber encased within fiberglass. This insulating element is then extended about the liner of a manifold. The liner may be ceramic or stainless steel, preferably stainless steel. A housing can then be cast or assembled around the liner and insulating element. An apparatus and method for insulating port liners was disclosed in U.S. Pat. No. 5,552,196 by Michael H. Haselkorn et al. A ceramic port liner is surrounded by an insulating blanket, as described in U.S. Pat. No. 5,404,716. The ceramic port liner and surrounding blanket can then be cast within a cylinder head. During the casting process, the ceramic port liner remains in a softened state.

There are problems associated with casting the ceramic liner, wrapped in insulation, into cast iron. These include: sealing, venting and support.

During casting, the cast iron must not contact the ceramic liner. The molten iron will thermally shock the ceramic material and cause failure. If the ceramic survives the thermal shock, then the solidification and shrinkage (thermal contraction) during cooling will compress the ceramic and cause either the ceramic or cast iron to fail.

Venting is also a problem. The insulation contains a large volume of air that expands when heated by the molten iron. The expanding air will cause large porosity defects in the cast iron if the air is not vented properly. The ceramic liner is impervious to air and prevents the normal venting of the insulation through the sand cores. Therefore, alternative venting routes have to be supplied.

Finally, the ceramic liner needs to be supported after casting. The ceramic liner must be permanently located within the cast iron housing. If the ceramic liner is cast-in within the cast iron contacting it, the ceramic is essentially floating free, held in place only by the compression of the insulation by the cast iron. The insulation compression may provide some support, by not sufficient support for long-term operation/resistance to engine vibration.

In U.S. Pat. No. 6,161,379 Haselkorn et al disclose a proposed solution to these issues in the form of a method for supporting a cast ceramic liner using a quilted insulating element and a metallic ring.

The claim is made that the manifold or port liner of this invention is of simple construction, compact, adapts itself to flexibility in construction and is solely internally insulated and thereby provides increased durability. The insulating element is thin and thereby conveniently adapts itself for use where engine space is severely limited, as for example in most marine applications. The metallic ring provides support, venting and sealing during the casting process.

The metallic ring and end cap used for casting into metal have holes or clearance machined to vent the air from the insulation into the sand core.

They also claim that the use of a liner, surrounded by an insulation layer, and supported by a metallic ring provides a simple, inexpensive and durable assembly and method to limit heat rejection for greater engine efficiency.

In the late 1970's the candidate material for the exhaust port was porous alumina. These ports were fabricated, cast into iron heads and experienced thermal shock failures. Steel port liners were plasma sprayed with zirconia coating and cast into ductile niresist iron heads with a high level of coating breakup and delamination.

In 1982 aluminum titanate ports were procured and cast into iron heads. Initially the port inserts experienced cracking during the casting process but with sand core material optimization the severity was reduced and eliminated with the use of a ceramic fiber cloth wrapping around the port. It was found that the aluminum titanate port material had gone through a sintering phase change as a result of the 2500° F. casting process temperature. The ports were engine tested with good results with no observed deterioration. It was concluded that a compliant layer to accommodate the iron shrinkage was primarily responsible for eliminating the port cracking.

Cummins has reported that aluminum titanate ports with 4 mm (0.120″) wall thickness with a compliant layer were successfully cast in the mid 1990's after a few design iterations. The ports were evaluated in a 125 mm bore single cylinder oil cooled L10 engine. It was reported that the measured port wall metal temperatures were reduced by an average of 180° F.

Aluminum titanate has also been the choice port material for Norton/TRW. They were able to successfully cast ports into aluminum cylinder heads with no compliant layer.

Aluminum titanate appears to have been the choice material selected and used by numerous investigators for thermal insulating exhaust port inserts. It is believed that additional improvements can be made to further advance the exhaust port state of the art. It is believed that advances in port liner material and processing to further improve the insulating effectiveness is possible along with manufacturing techniques to optimize cost, etc. One important issue is application of a compliant layer to improve reliability of the casting process. It is suggested that techniques such as ceramic fiber coatings can provide a cost-effective approach for establishing a compliant layer that can also potentially take advantage of controlled porosity to enhance thermal insulation.

### SUMMARY OF THE INVENTION

The present invention provides solutions to all of the aforementioned issues. In terms of cost and simplicity, the port liner material is made from inexpensive material that can be manufactured in complex shapes at high volume and low cost. From a foundry casting standpoint, no special processes or developmental materials will be required. The materials can be inserted into the casting mold in a manner similar to current casting cores and produced with existing equipment using current core and mold sands. The design of the compliant layer provides the heat resistance during casting as well as the durability needed in the application.

Exhaust port liner designs will be numerous because of the number of different engine manufacturers and designs. The cylindrical “coupon” as it was referred to herein is a simple way of describing a port liner material and can be produced inexpensively for test purposes. Actual port liners can be quite complex in design and would not exist in such a simple form. Complex shapes can be readily produced using current technology and, based on the diagnostic data outlined herein, can be cast in the same manner as the cylindrical sleeves into gray iron. These materials could also be cast into other metals such as aluminum or ductile iron.

The application of the compliant layer can also be made to complex shapes, although the process or technique may have to be refined for high-volume manufacturing.

The compliant layer is referred to as an insulating compliant layer herein because it serves a dual role as an insulator during casting and a thermo mechanical shield in the application. Earlier investigations of applying compliant layers to ceramic exhaust ports were conducted under the premise that a compliant layer was necessary to minimize the stress induced on the ceramic by the contracting metal. This is more the case in casting ceramics into metals such as aluminum due to higher thermal expansion and thus, the higher stress applied to the ceramic during cooling than in other metals such as iron, although the casting temperatures are relatively high for iron compared to metals such as aluminum. In iron casting, the compliant layer serves the dual purpose of minimizing mechanical stress but, more importantly, insulating the ceramic from the high temperature metal and distributing the heat uniformly across the ceramic to prevent differential heating and thermal shock of the ceramic. The proposed design should be applicable to casting in any metal, including gray iron, aluminum, ductile iron or any metal that may be used in an engine casting.

During casting, the heat insulation is required to keep the ceramic port from getting too hot. Fused silica needs to stay below approximately 2200° F. during the casting process to maintain the properties desired in the application. The temperature profiles and the predicted temperatures generated in heat transfer models reveals the maximum temperature to which the ceramic is exposed is approximately 1500° F., even though gray iron pouring temperatures exceed 2600° F.

Once the port is successfully cast into the metal in place on the engine, the maximum temperature that it will be exposed to from the engine exhaust is approximately 1800° F. However, it must withstand the thermal cycling cause by the engine as well as the vibration and thermal expansion/contraction difference between itself and the metal. The compliant layer will serve to dampen these effects and minimize the thermal and mechanical stress on the port during the application.

The compliant layer in ceramic form, if designed properly, should not negatively affect the metal casting. In the aforementioned U.S. Pat. No. 6,161,379 to Haselkom, two problems with traditional fiber compliant layers are discussed. These two problems are venting of trapped air during casting and settling of the refractory fibers in the casting during engine operation. Haselkorn claims that venting of the air pocket caused by the compliant layer during casting must be facilitated to prevent porosity defects in the cast iron. They claim that the settling of refractory fibers occurs during engine vibration may cause the insulating layer to be destroyed.

The compliant layer herein uses a ceramic fiber paper wrapped around the cylinder in combination with a ceramic fiber/silica sealant to seal the ends. This design, in its present form, is more applicable to simple geometries and prototype assemblies, although it could be automated through the use of automated machinery used to handle paper and ceramic coatings. The fiber coating and filler composition, if designed properly, should not undergo settling during engine vibration.

There are two additional compliant layer designs that are contemplated herein.

The first design uses similar materials, i.e., ceramic fibers in combination with silica particles. This design would be batched into a coating and applied to the surface of the port with a nozzle. This design would be the easiest to automate and apply to complex surfaces containing contours. The combination of alumina-silica ceramic fiber and silica particles provides a compliant layer that will expand with the metal upon heat-up by the exhaust, securing the fused silica port in place during the thermal cycling of the engine.

The second design utilizes a combination of silica particles imbedded in a porous material such as ceramic or glass fiber or foam and the resulting composite applied to the outside of the port. This design is believed to be the least likely to have any negative issues arising from the venting and settling problems described in U.S. Pat. No. 6,161,379 to Haselkorn. This design also may utilize ceramic fiber and silica particles, but has the added benefit of a continuous ceramic layer in place to further dampen the effects of the engine vibration and thermal cycling.

### BRIEF DESCRIPTION OF THE DRAWINGS

The various embodiments, features and advances of the present invention will be understood more completely hereinafter as a result of a detailed description thereof in which reference will be made to the following drawings:

FIG. 1a is an illustration of the liner port-casting configuration;

FIG. 1b is a photograph of a port liner coupon;

FIGS. 2a and 2b are photographs of a sand-cored and compliant layer wrapped port liner assembly wherein the port liner coupon is wrapped (protected) after the core sand is introduced;

FIGS. 3a and 3b are photographs of the port liner core and mold assembly;

FIG. 4 shows the actual casting process;

FIG. 5a shows the fused silica port liner casting;

FIG. 5b shows the fused silica port liner casting was successful with no cracks visible; and

FIGS. 6a and 6b show the temperature measurements of the port liner inner wall surface wherein the maximum temperature of 1370° F. was reached at five seconds after the 2650° F. cast iron was poured.

### DETAILED DESCRIPTION OF PREFERRED EMBODIMENTS

Fused silica has excellent thermal properties that make it attractive in applications where good insulation and thermal shock resistance are desired. However, it has a temperature use/exposure limit of approximately 2200° F. For this reason, a monolithic fused silica material has not been considered in casting applications in which the pouring temperatures are above this use limit. Most of the prior art involves the use of more exotic materials that have higher temperature use limits and a broad range of mechanical properties along with higher cost. Among these are materials such as aluminum titanate, NZP, silicon nitride, ceramic fiber-containing composites and some metallic alloys.

A fused silica port liner coupon was successfully cast into gray iron by the Applicant hereof. The coupon measured 1.6″ inner diameter by 4″ length and 0.14″ wall thickness. The insert coupon was wrapped with an aluminosilicate fiber blanket to provide an insulating compliant layer to facilitate the casting process. Casting was accomplished with standard foundry core sand.

Fused silica is an attractive material for the thermal insulating exhaust port runner application because it is an extremely low cost material and can be produced by relatively low cost manufacturing processes including traditional casting techniques as well as pressure casting, gel casting and injection molding. Early successful investigations use aluminum titanate which is estimated to have a raw material cost 50 times higher than fused silica ($0.32/lbm). However the inventors hereof are not aware of any casting activities with fused silica for such an application. Therefore it was considered to be important to show feasibility to cast fused silica and then develop a cost effective compliant layer. It is believed that a low cost, porous ceramic material can be used for the compliant layer application. Another advantage with fused silica is a thermal conductivity (1.32 S/K-C) that is nearly 20% lower than aluminum titanate. The fused silica should be at least 98% pure amorphous silica.

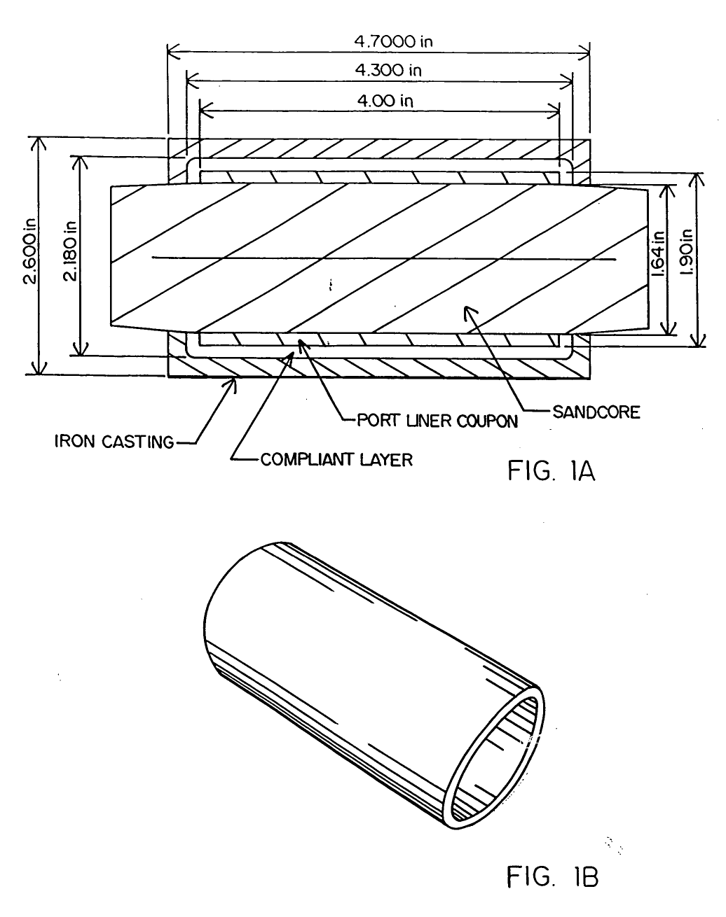

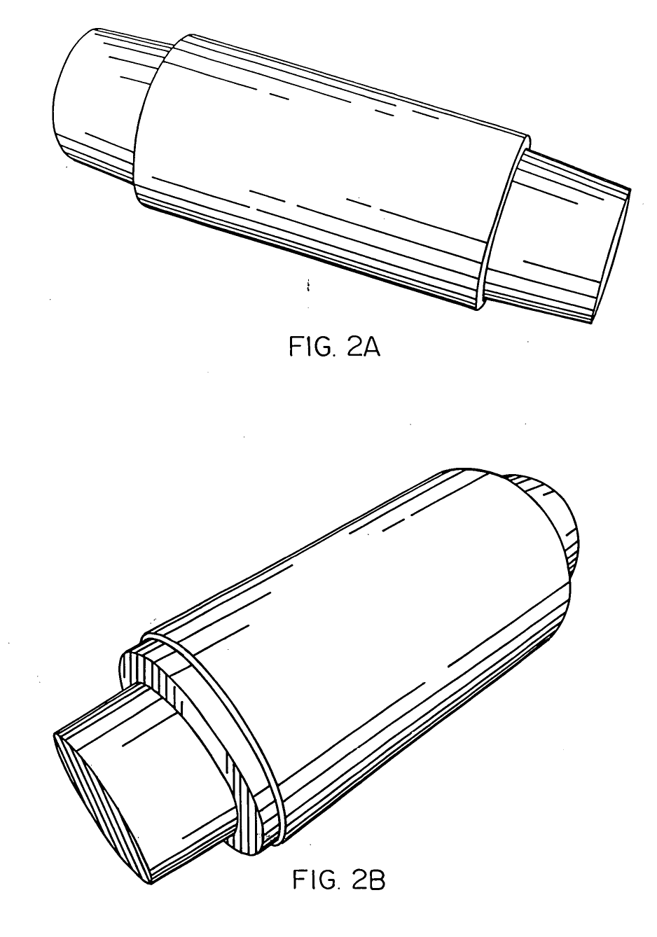

An illustration of the liner port-casting configuration is included in FIGS. 1a and 1b along with a photograph of a port liner coupon. Photographs of a sand-cored and compliant layer wrapped port liner assembly are included in FIGS. 2a and 2b. The port liner coupon is wrapped (protected) after the core sand is introduced. The insulating compliant layer assures that molten iron does not come into contact with the port liner. In addition, the compliant layer helps to control the maximum temperature that the insert reaches during the casting process and helps to control the mechanical loading applied to the insert when the iron solidifies and shrinks down on the insert.

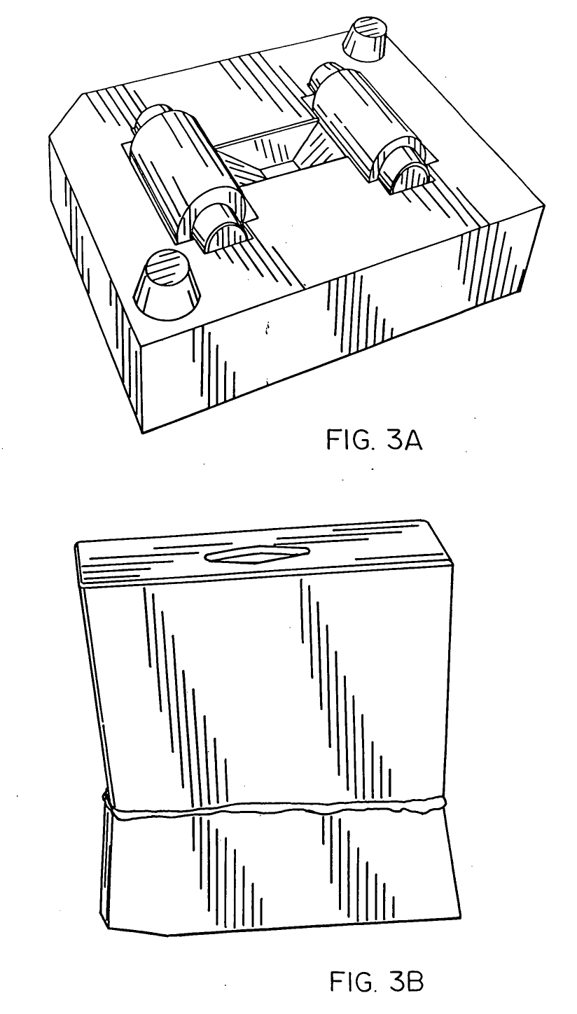

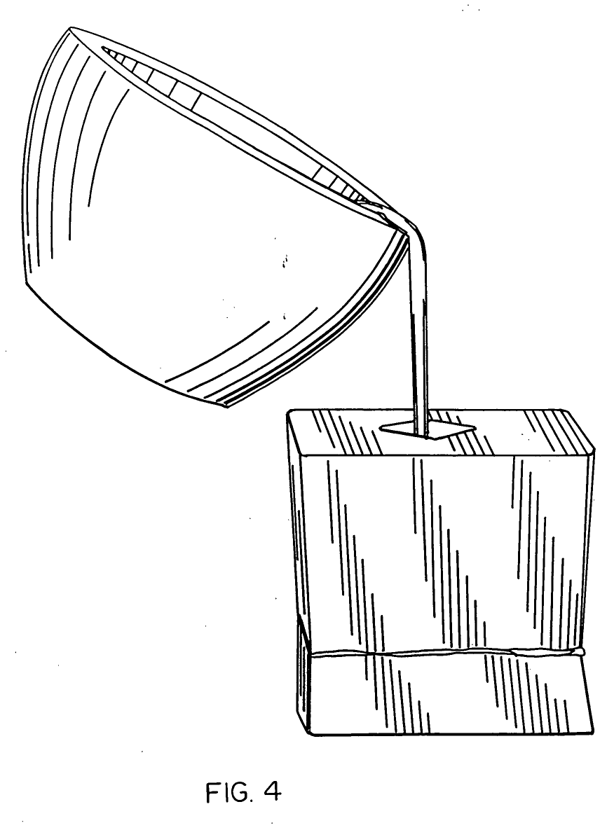

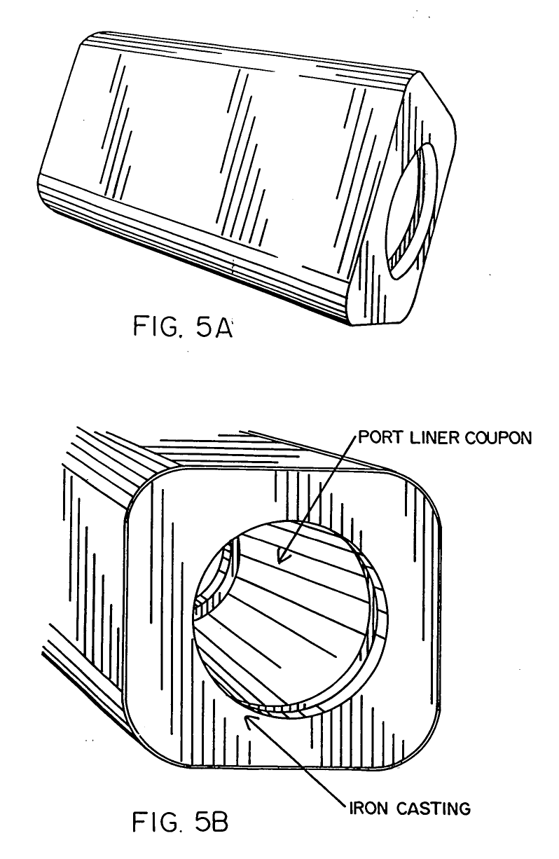

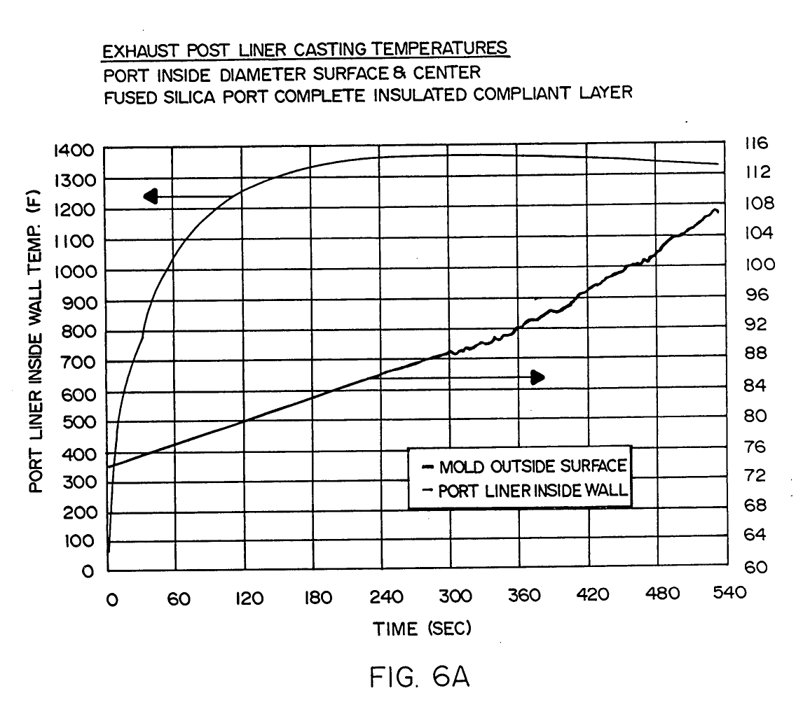

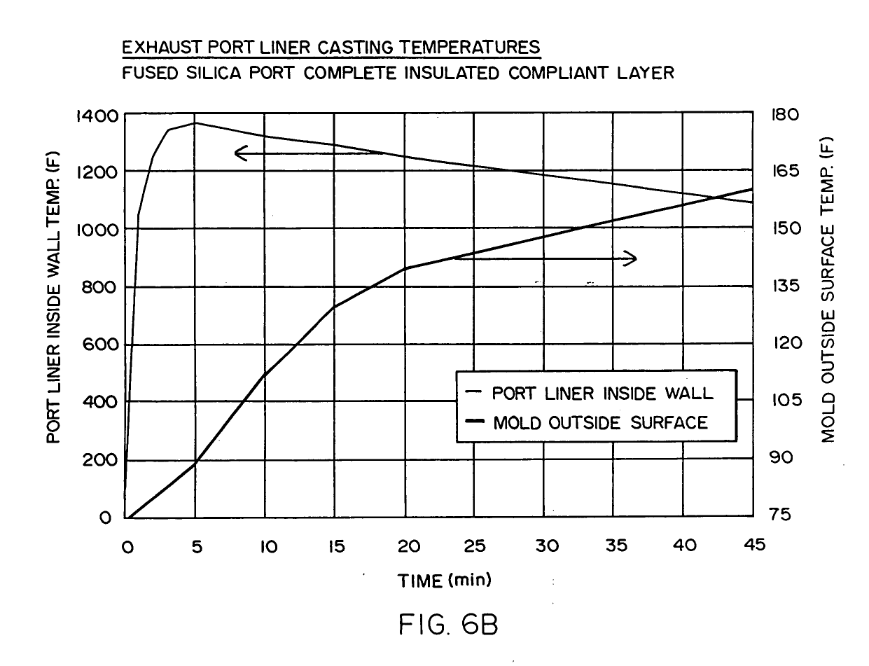

The port liner core and mold assembly are shown in FIGS. 3a and 3b with the actual casting process shown in FIG. 4. A first casting attempt with fused silica port liners ended in failures. Both assemblies were wrapped only around the outer diameter surfaces with no protection on the ends. It was concluded that the failures were caused by a combination of high insert temperature and high mechanical crush on the ends that weren't protected with insulating compliant layers. An insulating compliant layer was added to the ends of the next two inserts. One fused silica and one aluminum titanate port liner were used with a thermocouple added to the fused silica liner inner surface. Fused silica port liner casting (FIGS. 5a and 5b) was successful with no cracks visible. The aluminum titanate port liner had one crack down the entire length. The temperature measurements included in FIGS. 6a and 6b show that the port liner inner wall surface reached a maximum temperature of 1370° F. at five seconds after the 2650° F. cast iron was poured. FEM modeling analysis estimates that the port liner outer wall temperature reached a maximum of 1500° F.

In the preferred embodiment the port liner is a contoured tube made of fused silica having a minimum purity of 98% amorphous silica. The outer surface of the liner is wrapped with at least one layer of compliant fibrous ceramic or glass secured to the outer surface by a layer of colloidal silica or similar type glue. The fibrous ceramic may be in the form of fiber, mat or paper and may be sealed in a heat resistant silica particle sealant and encased by a porous fused silica or porous ceramic having a thickness in the range of 0.1 to 1.0 inches. The tube surface may also have an inner layer covering of 10% to 50% chopped ceramic or glass fiber, 0% to 50% fused silica grain and 0% to 50% crystalline silica having primarily a cristobolite structure.

Having thus disclosed a novel and highly advantageous use of fused silica exhaust port liners cast into gray iron while insulated by a compliant layer of various alternative embodiments, it will now be apparent that the invention hereof may be modified by employing other materials and other combinations of the disclosed materials. Therefore, the scope hereof is to be limited only by the appended claims and their equivalents.

We claim:

1. (canceled)

2. A port liner for lining a port of an internal combustion engine; the port liner comprising:
a contoured tube made of fused silica having a minimum purity of 98% amorphous silica;
further comprising an outer surface wrapped with at least one layer of fibrous ceramic or glass secured to said surface by a layer of colloidal silica or similar type glue.

3. The port liner recited in claim 2 wherein said ceramic is in a form taken from the group consisting of fiber, mat and paper.

4. A port liner for lining a port of an internal combustion engine: the port liner comprising:
a contoured tube made of fused silica having a minimum Purity of 98% amorphous silica:
further comprising an outer surface sprayed with at least one layer of fibrous ceramic.

5. A port liner for lining a port of an internal combustion engine; the port liner comprising:
a contoured tube made of fused silica having a minimum purity of 98% amorphous silica:
wherein said contoured tube has an outer surface covered in a ceramic or glass fiber paper sealed with a heat resistant sealant and an inner layer comprising of approximately 10% to 50% chopped ceramic or glass fiber, 0% to 50% fused silica grain and 0% to 50% crystalline silica having primarily a cristobolite structure.

6. The port liner recited in claim 5 further comprising a porous fused silica or porous ceramic encasing said ceramic fiber and sealant.

7. The port liner recited in claim 6 wherein said fused silica or ceramic has a thickness in the range of about 0.1 inch to 1.0 inch.

8. (canceled)

9. A port liner for use in an internal combustion engine wherein the port liner is made of fused silica cast into a metal engine head, the engine head metal taken from the group of metals consisting of gray iron, aluminum and ductile iron; and
wherein said liner is insulated during casting of said liner into said metal engine head, the liner insulation comprising a compliant layer of ceramic fiber paper wrapped around the liner and sealed therein with a ceramic fiber and silica or similar type sealant.

10. A port liner for use in an internal combustion engine wherein the port liner is made of fused silica cast into a metal engine head, the engine head metal taken from the group of metals consisting of gray iron, aluminum and ductile iron; and
wherein said liner is insulated during casting of said liner into said metal engine head, the liner insulation comprising a compliant layer of ceramic fiber paper wrapped around the liner and sealed therein with ceramic or glass fibers and silica particle sealant.

11. A port liner for use in an internal combustion engine wherein the port liner is made of fused silica cast into a metal engine head, the engine head metal taken from the group of metals consisting of gray iron, aluminum and ductile iron; and
wherein said liner is insulated during casting of said liner into said metal engine head, the liner insulation comprising a compliant layer of ceramic fiber paper wrapped around the liner and sealed therein with silica particles imbedded in porous ceramic.
